(19) United States
(12) Patent Application Publication
(10) Pub. No.: US 2007/0043710 A1
(43) Pub. Date: Feb. 22, 2007

(54) SEARCHROLL SYSTEM

(76) Inventor: DAVID PELL, San Francisco, CA (US)

Correspondence Address: PERKINS COIE LLP, P.O. BOX 2168, MENLO PARK, CA, 94026, US

(21) Appl. No.: 11/466,413

(22) Filed: Aug. 22, 2006

Related U.S. Application Data
(60) Provisional application No. 60/710,506, filed on Aug. 22, 2005.

(51) Int. Cl. G06F 17/30

(52) U.S. Cl. 707/3

(57) ABSTRACT

In an embodiment, a method is presented. The method includes receiving a request to create a searchroll. The method also includes receiving a list of sites. The method further includes creating a searchroll to enable searching of the list of sites.

### CLAIM OF PRIORITY

This application claims the benefit of U.S. Provisional Patent Application No. 60/710,506 filed Aug. 22, 2005, which is hereby incorporated herein in its entirety by reference.

### BACKGROUND

With the advent of the Internet, vast quantities of data became accessible electronically. More people can access data on a variety of subjects now than at any time prior to the explosive growth of the Internet in the late 1990s. This is a net positive, as the dissemination of information is generally favorable to advances and innovation.

However, the Internet has been likened to a graffiti wall. Anyone can post anything on a webpage. Such webpages are then available for searching by inexperienced users who may or may not recognize a webpage as lacking credibility.

Search engines typically provide minimal or no assistance in this area. The page rank algorithm of google, for example, generally relates to popularity of websites. Thus, if a website is popular but incorrect, a search engine such as google will provide search results for that website, without indicating the information there is flawed. Thus, it may be useful to provide an opportunity to search websites which a knowledgeable person believes are useful.

Additionally, most search engines allow two options. Either a single site may be searched, or the search engine approximation of the entire Internet may be searched. However, being able to search a preset group of websites may also be useful.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a method of forming a roll of websites.

FIG. 2 illustrates an embodiment of a method of searching a roll of websites.

FIG. 3 illustrates an embodiment of a system using searchrolls.

FIG. 4 illustrates an embodiment of advertising flow in relation to a searchroll website.

FIG. 5 illustrates an embodiment of a method of editing a searchroll.

FIG. 6 illustrates an embodiment of a medium which may embody a searchroll website.

FIG. 7 illustrates an embodiment of a network which may be used with a searchroll website.

FIG. 8 illustrates an embodiment of a computer which may be used with the network of FIG. 7, for example.

FIG. 9 illustrates an embodiment of a user interface for creation of a searchroll.

FIG. 10 illustrates an embodiment of a user interface for interaction with searchrolls.

FIG. 11 illustrates an embodiment of another user interface for interaction with searchrolls.

FIG. 12 illustrates the embodiment of FIG. 11 with an expanded searchroll.

FIGS. 13 and 14 illustrate an embodiment of a user interface providing results of use of a searchroll.

### DETAILED DESCRIPTION

A system, method and apparatus is provided for a searchroll system. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

Searchrolls may be understood as a mechanism which allows for searches of a predetermined group of sites through use of a search engine. This may be implemented through use of a website separate from a search engine portal. The website may maintain a set of searchrolls for access by the public or members. Each searchroll may include a predetermined set of websites which are to be searched. A user may then submit a search for a designated searchroll with keywords as would be done for other searches, and receive back results of a search of just the predetermined set of websites. This potentially allows users to use searchrolls created by others, thereby allowing for a search of sites as may be selected by an expert instead of a lay person in a given field. Note that sites need not solely refer to websites—the term may also refer to feeds of various forms, such as feeds available through RSS (Really Simple Syndication), for example.

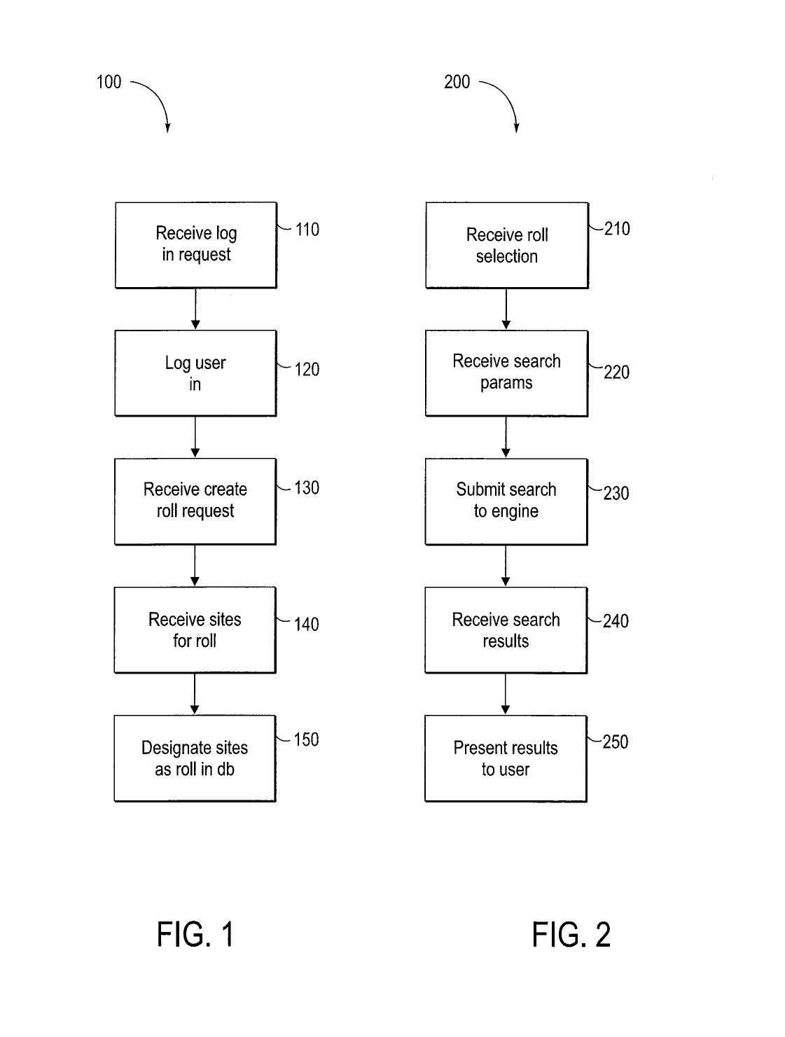

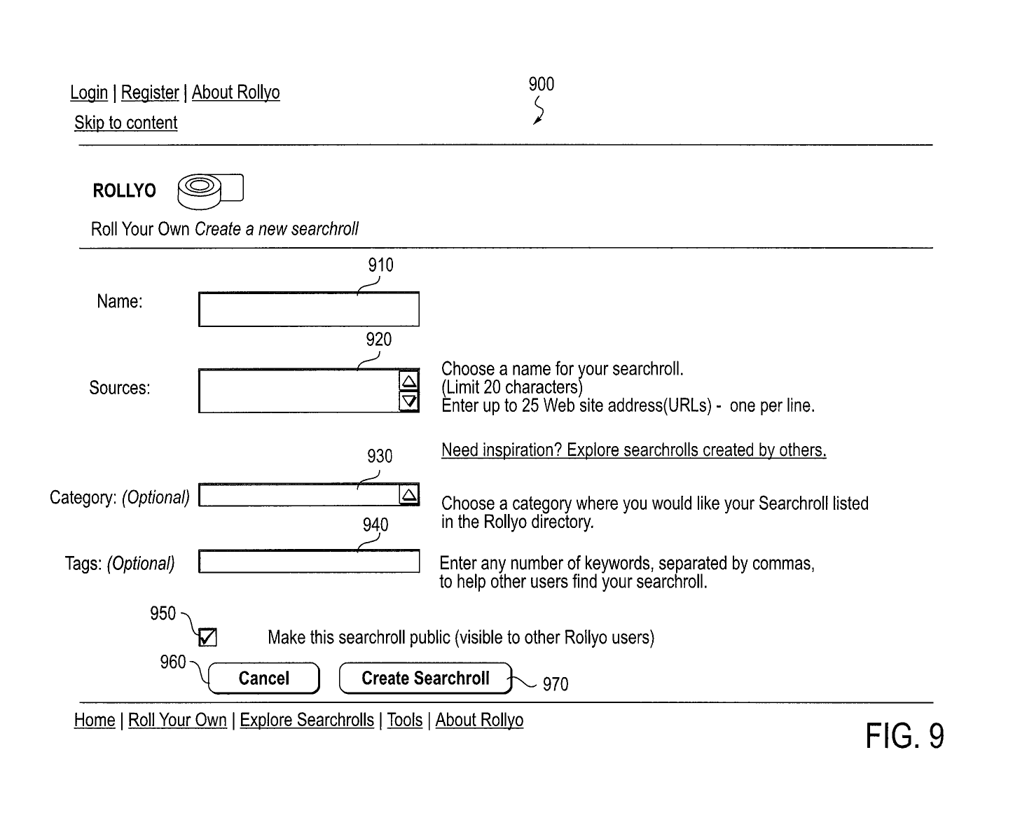

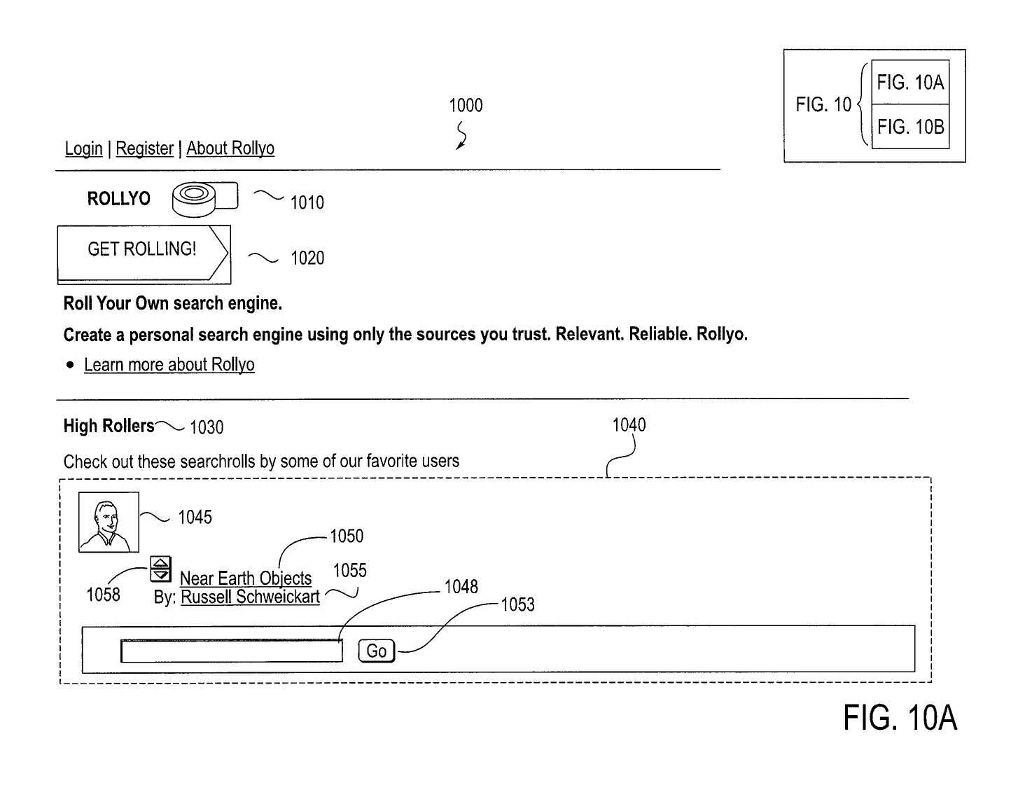

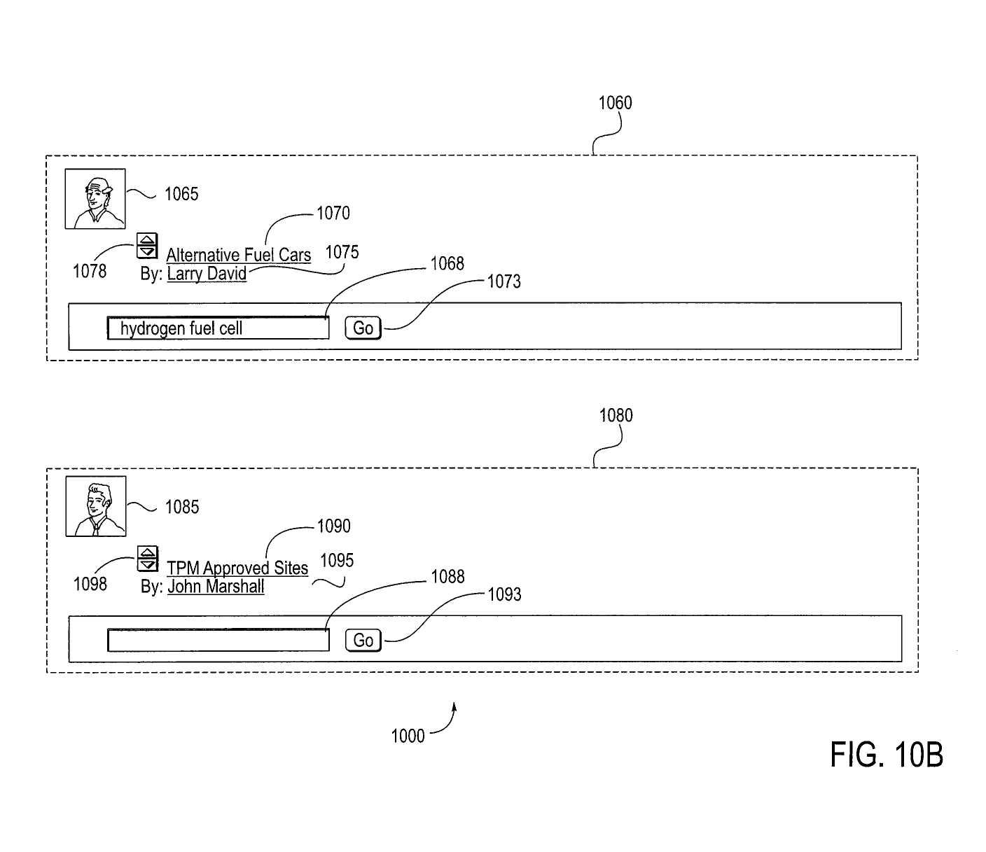

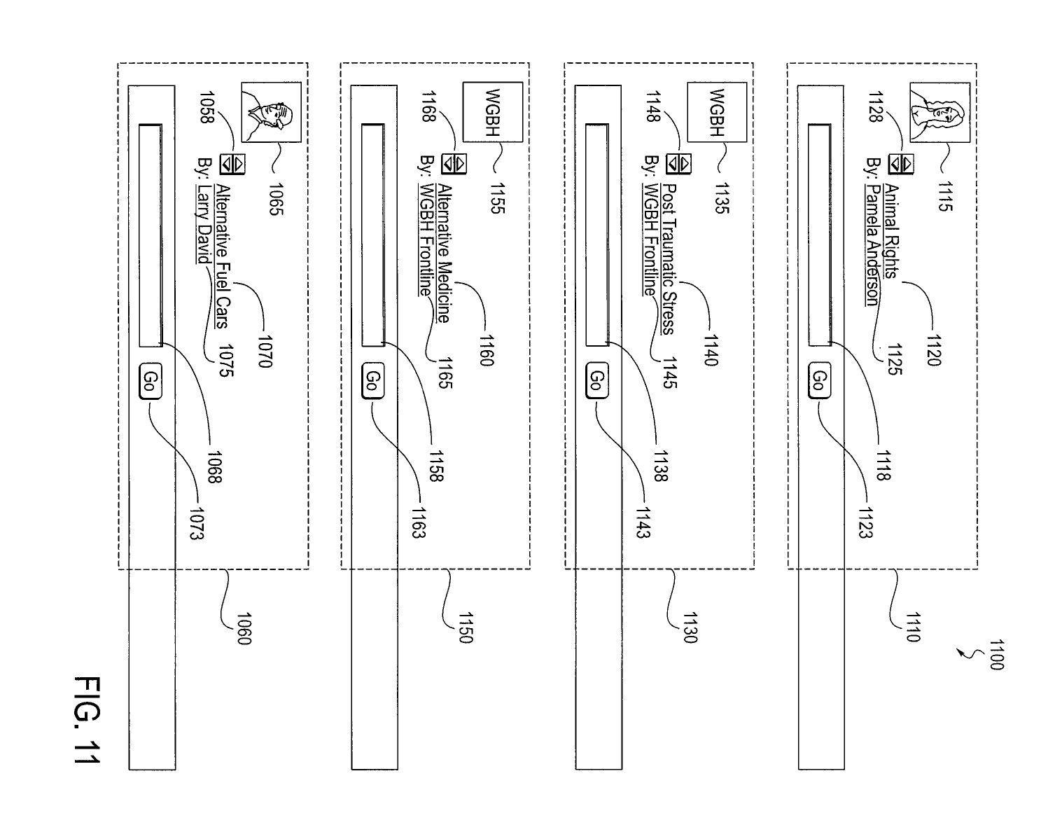

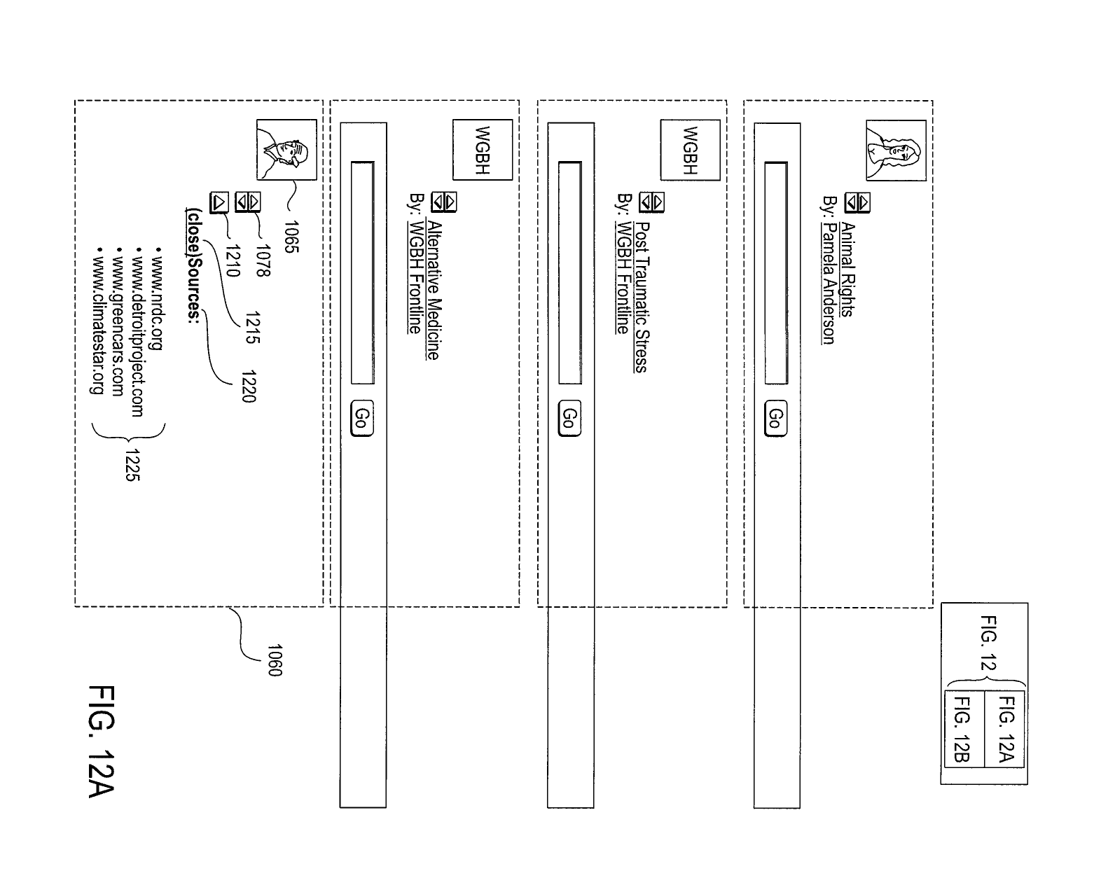

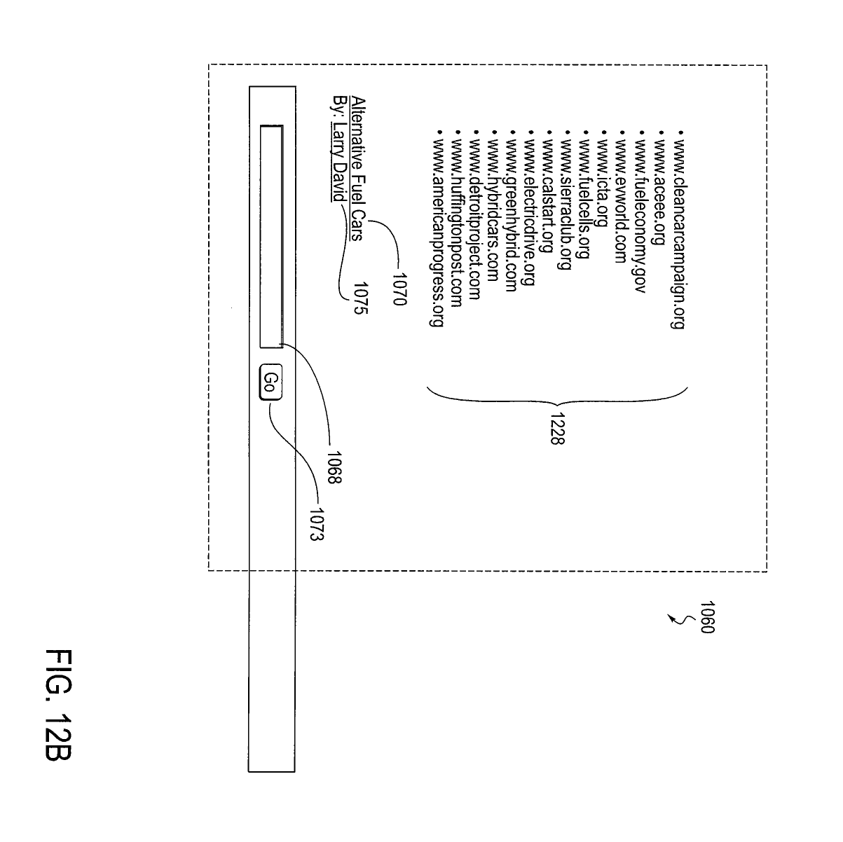

FIG. 1 illustrates an embodiment of a method of forming a roll of websites. Method 100 includes receiving a log in request, logging a user in, receiving a roll creation request, receiving websites for a roll, and creating a searchroll. Method 100 begins with receipt of a log in request at module 110. At module 120, the user is logged in to a searchroll site, allowing for creation of searchrolls. A request for creation of a searchroll is then received at module 130. Additionally, at module 140, sites for a searchroll are received, such as through receipt of a list of URLs (Universal Resource Locators), for example. At module 150, the set of sites is designated as a searchroll, such as through storage in a database along with user identification information and a title of the searchroll, for example. An example of a searchroll creation user interface may be found in FIG. 9. Similarly, an example of a usable searchroll may be found in FIG. 10.

Note that searchrolls are often intended to be a public facility—something which others can use to search a set of websites based on the expertise, interest, or public relations effort of the creator of a searchroll. However, it may be appropriate to designate some searchrolls as private in some circumstances, and not allow access to other users. Additionally, an internal searchroll website may be an appropriate implementation—a website available on an Intranet for use by employees of a company for example, which may be public within the company but unavailable otherwise (and presumably using a local search engine rather than a public search engine). Also, note that method/process 100 may be utilized many times by individual users—a user may have a number of searchrolls in existence at a given time.

With a searchroll in existence, it may be used by searching the searchroll. FIG. 2 illustrates an embodiment of a method of searching a roll of websites. Method 200 includes receiving a searchroll selection, receiving search parameters, submitting a search of the searchroll to a search engine, receiving results from the search engine, and presenting the results to a user.

A searchroll is selected at module 210. Selection may be by choosing from a list of available searchrolls (either made by the user or others). Search parameters are provided at module 220, such as keywords or phrases, for example. This may occur through a simple form or dialog box on a website for example. The parameters are submitted to a search engine along with information identifying the websites of the selected searchroll at module 230. The API of the Yahoo website supports submission of a set of websites for a restricted search, for example. Results of the search are received from the search engine at module 240. These results may simply be search results, or may also include targeted advertisements, for example. These results are then displayed or otherwise presented to the user at module 250. Display or presentation may involve simply displaying the data, or somehow manipulating or massaging the data for display.

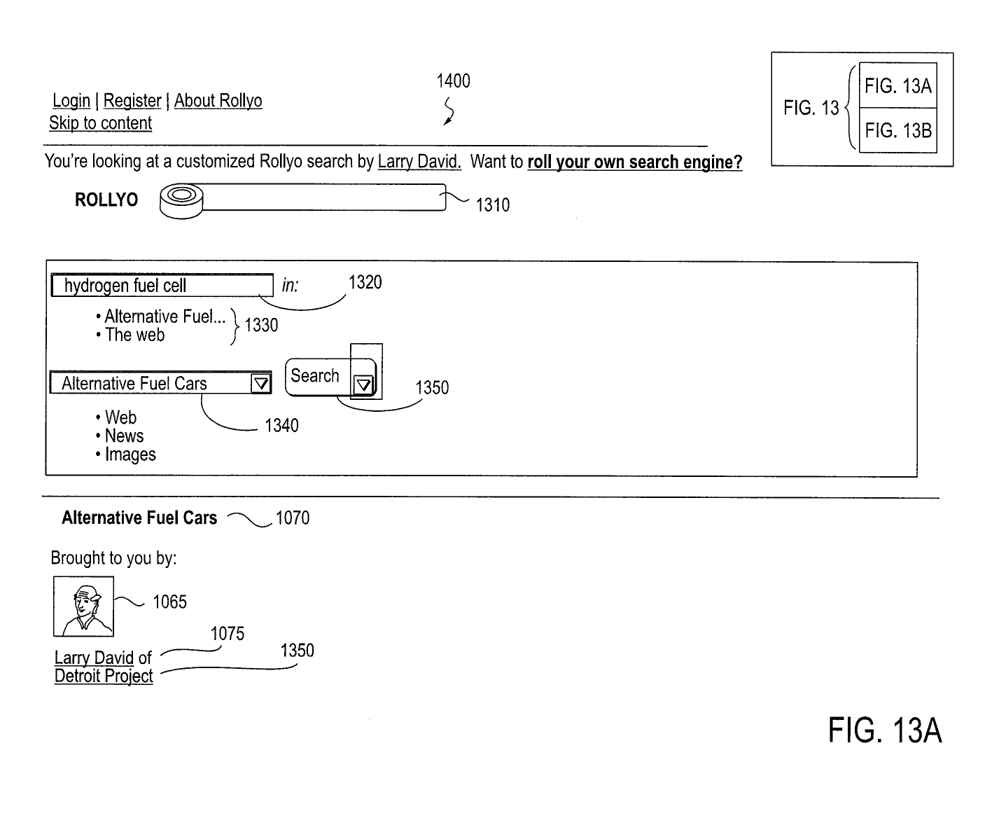

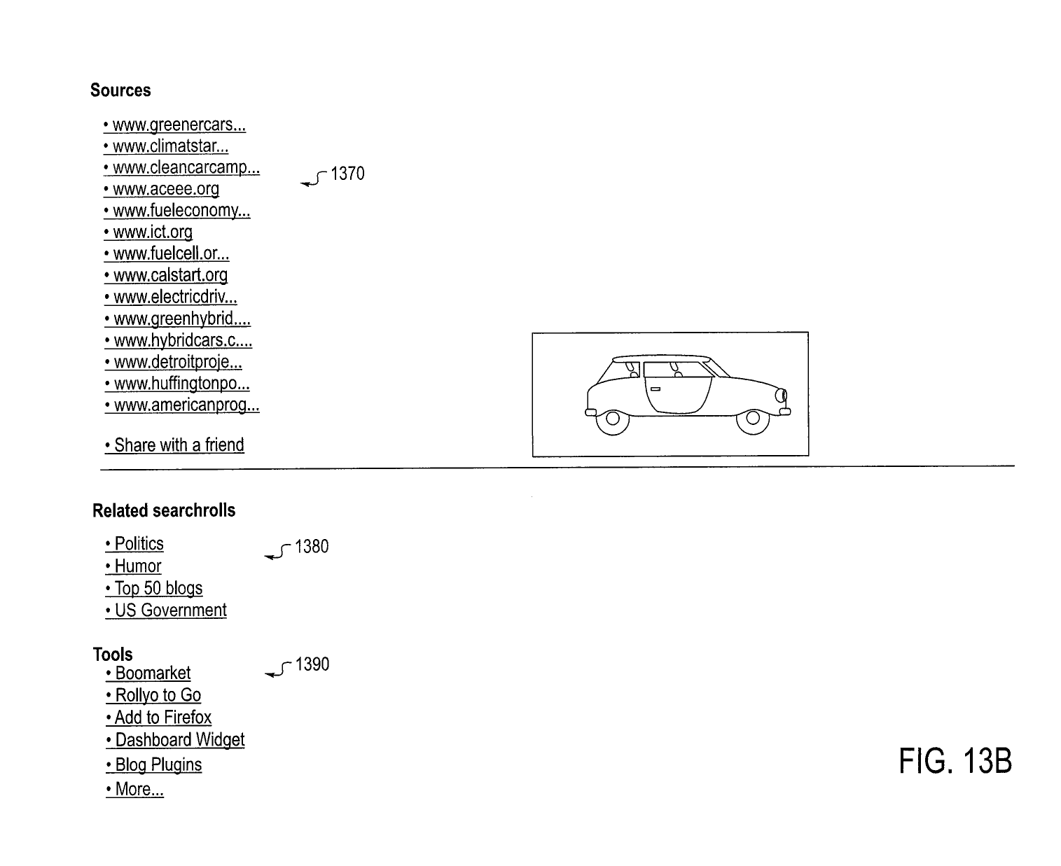

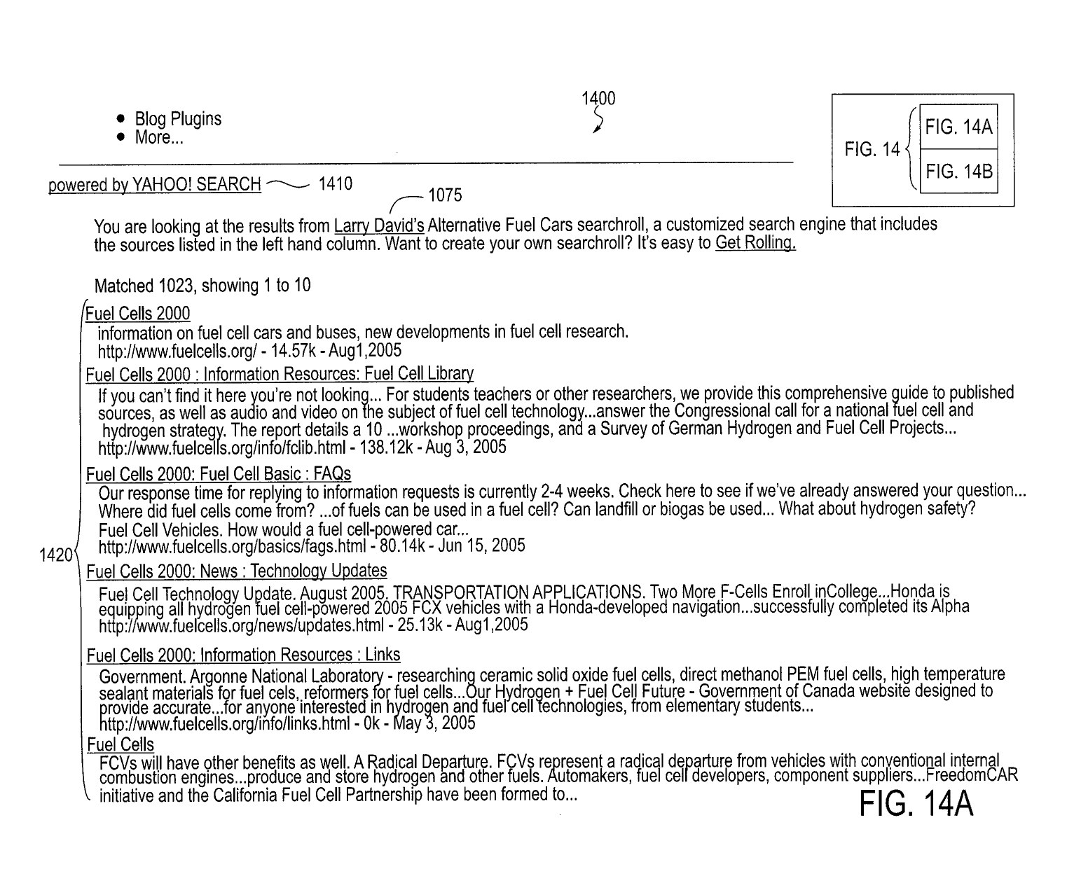

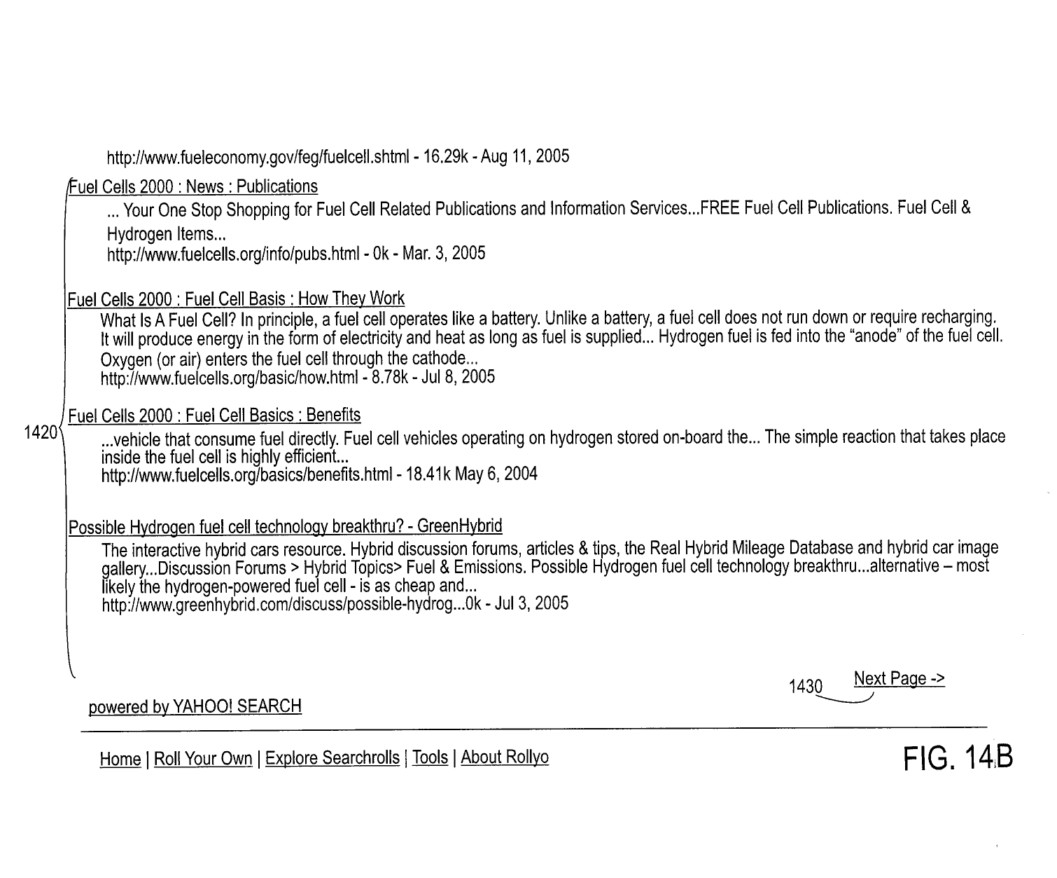

FIG. 14 illustrates a presentation format of results of a search in one embodiment. In another embodiment, FIGS. 13 and 14 present the search. Collectively, FIGS. 13 and 14 provide more information about where the search was conducted (e.g. the websites of the searchroll).

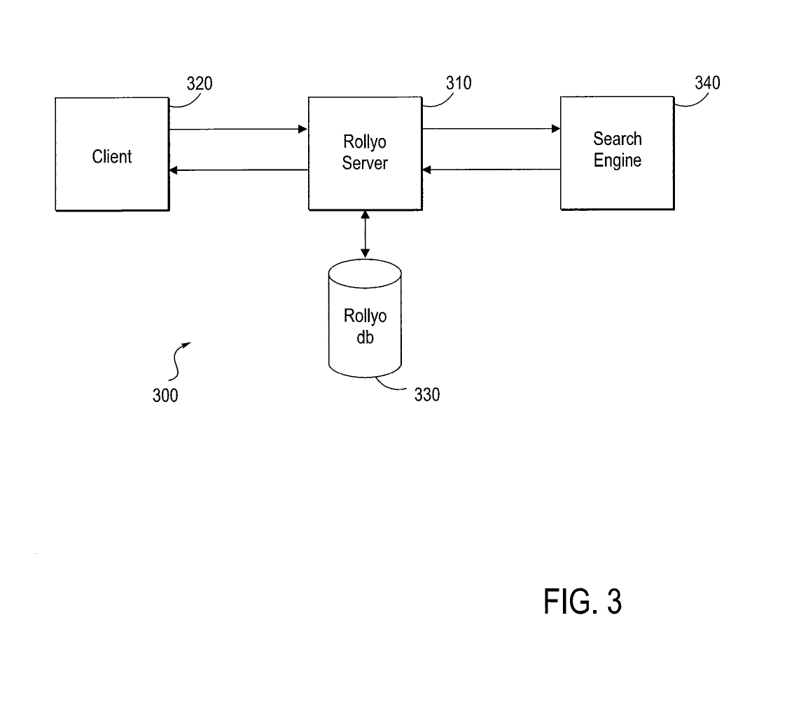

A system in which such searchrolls may be used may also be illustrative. FIG. 3 illustrates an embodiment of a system using searchrolls. System 300 includes a server, client (user terminal/device), search engine server/interface, and a database. Other embodiments of a system may be used to provide similar functions with different components.

System 300 includes searchroll server 310, which implements the searchroll website or portal. Such a server 310 may be accessible by a client 320, allowing a user to interact with server 310 thereby. Server 310 may also interact with search engine 340, such as by submitting search parameters and designated websites for searching. Server 310 may also store and retrieve designated websites of various searchrolls at database 330.

Thus, a user may access client 320, and thereby access server 310. In accessing server 310, the user may choose a searchroll and submit search parameters. Choosing the searchroll may involve accessing searchroll websites from a database 330. Submitting search parameters may then result in submission of designated websites and search parameters to search engine 340. Search engine 340 may return search results to server 310, which may then present those search results to client 320.

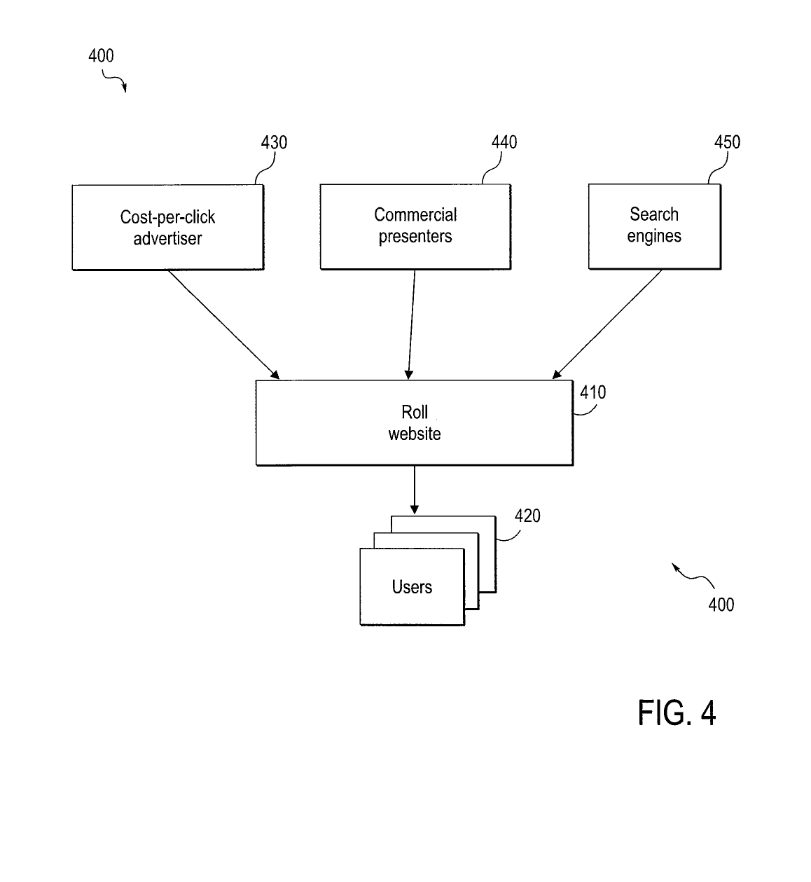

A searchroll website may also be useful in displaying advertising from a variety of sources. FIG. 4 illustrates an embodiment of advertising flow in relation to a searchroll website. System 400 provides a searchroll website/portal, advertising sources, and users (advertising targets).

Searchroll website 410 provides searchroll services such as were described with respect to FIGS. 1-3, for example. Cost-per-click advertisers 430 (such as doubleclick for example) can provide a stream of advertisements, and potential revenue. Additionally, commercial presenters 440 may provide searchrolls with websites related to the goods or services sold by the presenter 440. The commercial presenter 440 may then provide a logo or related illustration for use in their searchrolls, and may potentially also provide advertisements otherwise used by the website 410. Similarly, search engines 450 may be used to run searches for searchrolls, and may also serve up advertisements based on search keywords or results. All of these advertisements may then be viewed and potentially accessed by users 420 of the website 410.

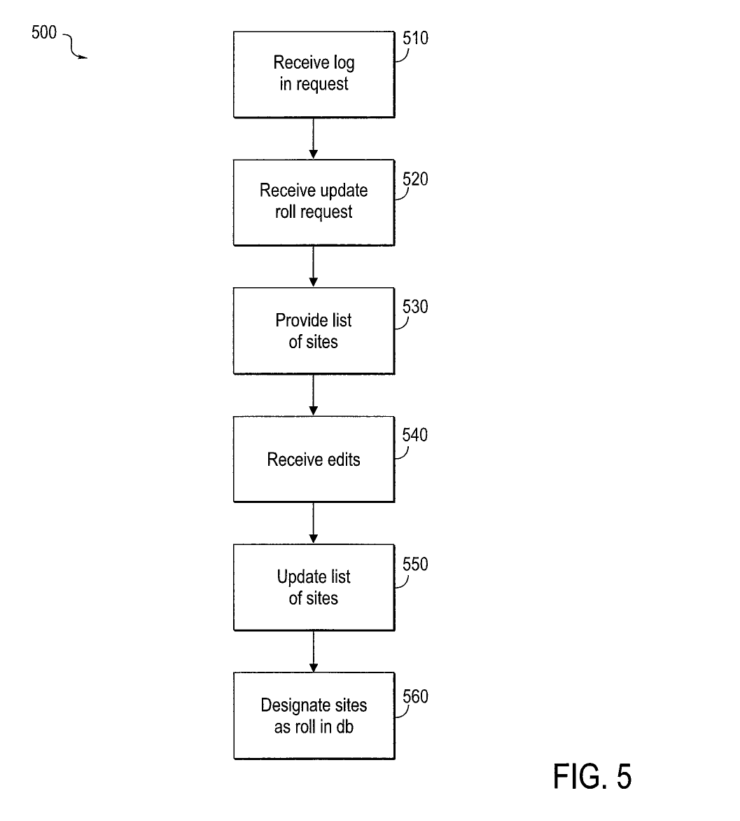

After a time, a searchroll may become out of date. Old websites may become stale or out of touch with new developments (or disappear). Newer websites may come along with better content. FIG. 5 illustrates an embodiment of a method of editing a searchroll. Process 500 includes receiving a log in request, logging a user in, receiving an update roll request, providing a current list of sites, receiving edits, updating the list of sites, and designating the updated list of sites as the searchroll in a database.

At module 510, a log in request is received, and a user is logged in. Note that logging in for methods of this document may be optional in many instances, or may be automatically accomplished through stored user identification information, for example. At module 520, an update searchroll request is received, identifying a searchroll to be updated. At module 530, a list of sites for the identified searchroll is provided to the logged in user, such as by accessing the list of sites in a database, for example.

At module 540, edits to the list of sites are received, such as additions of new sites, deletions of old sites, or some combination of the two. Exceeding a preset limit on number of sites may trigger a loop requiring deletion of additional sites in some embodiments. At module 550, the list of sites is updated to illustrate the net effect of edits of module 540. This may involve approval of a final list by the user, for example. At module 560, the updated list of sites is designated as the searchroll list of sites within a database or similar data store.

Other reasons for editing a searchroll may exist as well. For example, a shift in a person's focus or interests may result in a desire to change the searchroll. Whim may come into play as well. Note that in some embodiments, a user may be allowed to edit another user's searchroll. This may be accomplished when a user gives permission for third-party edits, or in embodiments where editing is available to all. Moreover, this may result in a separate, custom searchroll, or in edits to the original searchroll. This may further obviate the login process—it may not be necessary to login at all in order to edit searchrolls.

Other options for using a searchroll or adding to a searchroll may also be implemented. For example, a bookmarklet may be used which may allow a visited website to be searched (using a query) and bookmarked into a searchroll. In bookmarking the site into a searchroll, the searchroll has the website added to the searchroll without requiring a visit to the searchroll editing site. Rather, the addition is handled as part of the use of the bookmarklet. Similarly, a searchroll dialog box may be added to a browser, such as Firefox or other browsers allowing for extensions. The searchroll dialog box may be part of a toolbar within the browser or other extension to the browser, allowing for a search query to be entered and searched against the searchroll regardless of what site is being visited.

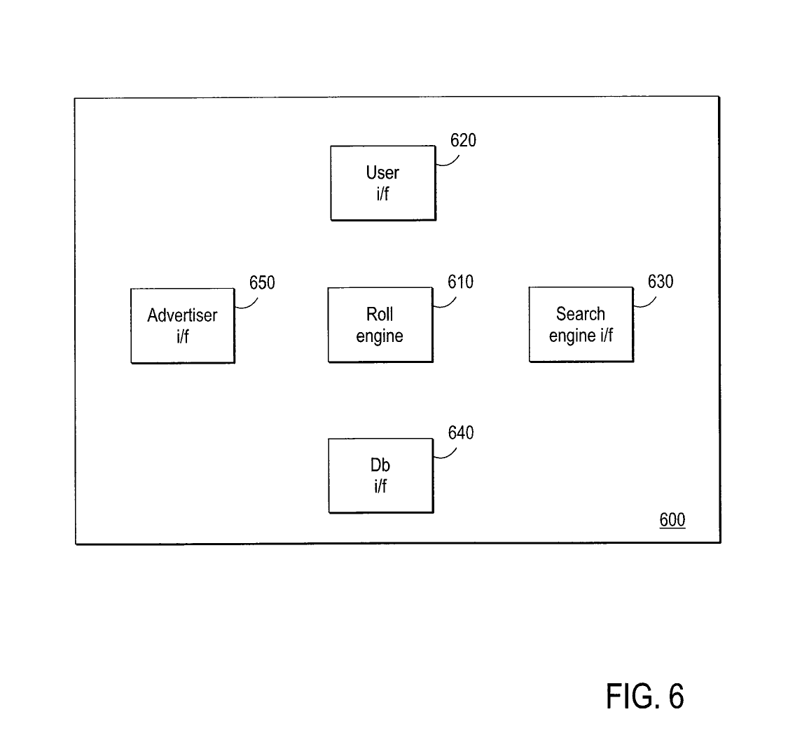

The software involved in a searchroll website may be embodied in a machine-readable medium. FIG. 6 illustrates an embodiment of a medium which may embody a searchroll website. Medium 600 embodies the searchroll engine and a set of interfaces to other engines or data, for example.

Medium 600 includes searchroll engine 610. It also includes user interface 620, which may be used in interacting with users of the website. Medium 600 further embodies search engine interface 630. A search engine such a yahoo or google may require certain behavior from users. For example, a limited number of searches each day may be a requirement. Such a requirement would not be a problem for most users, but would for a searchroll website. Similarly, a search format may be necessary for searches of multiple websites. Thus, search engine interface 630 may have a variety of requirements.

Also embodied is database interface 640. Databases of searchrolls may be an efficient means of storing information about the rolls, and database interface 640 may implement this process. Further embodied is advertiser interface 650, which may accept advertising or process advertisements provided through search engines or cost-per-click models, for example.

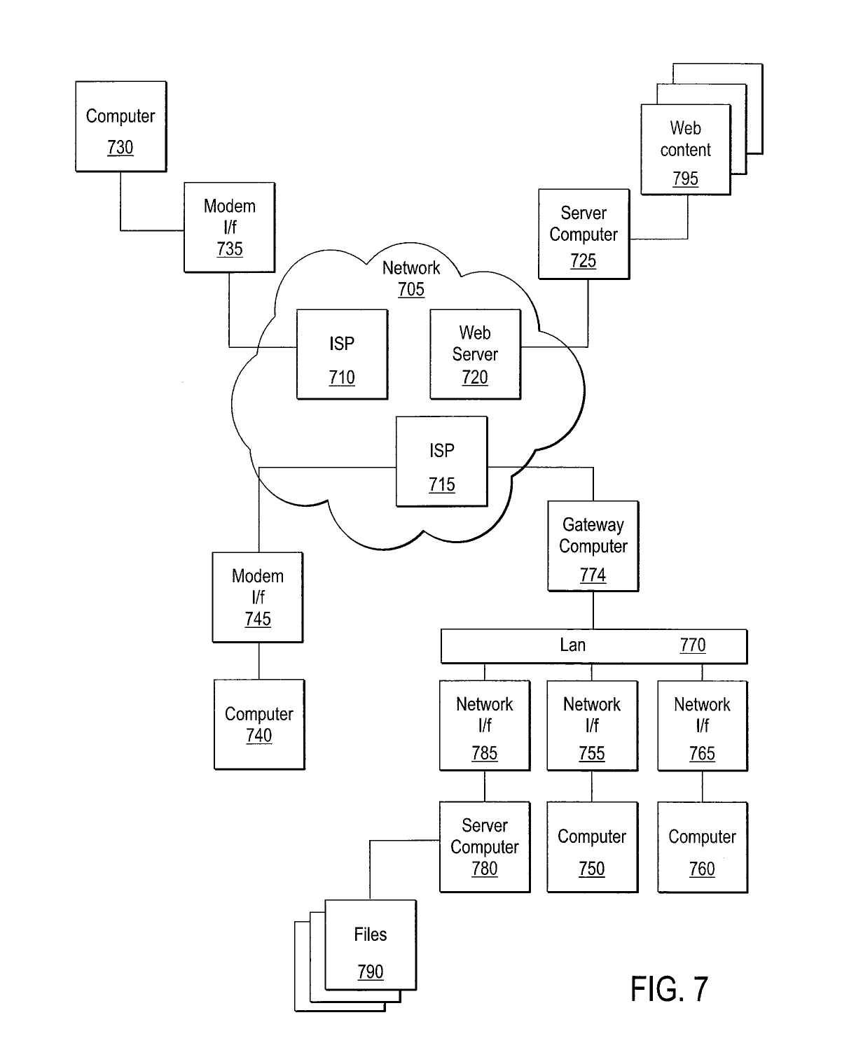

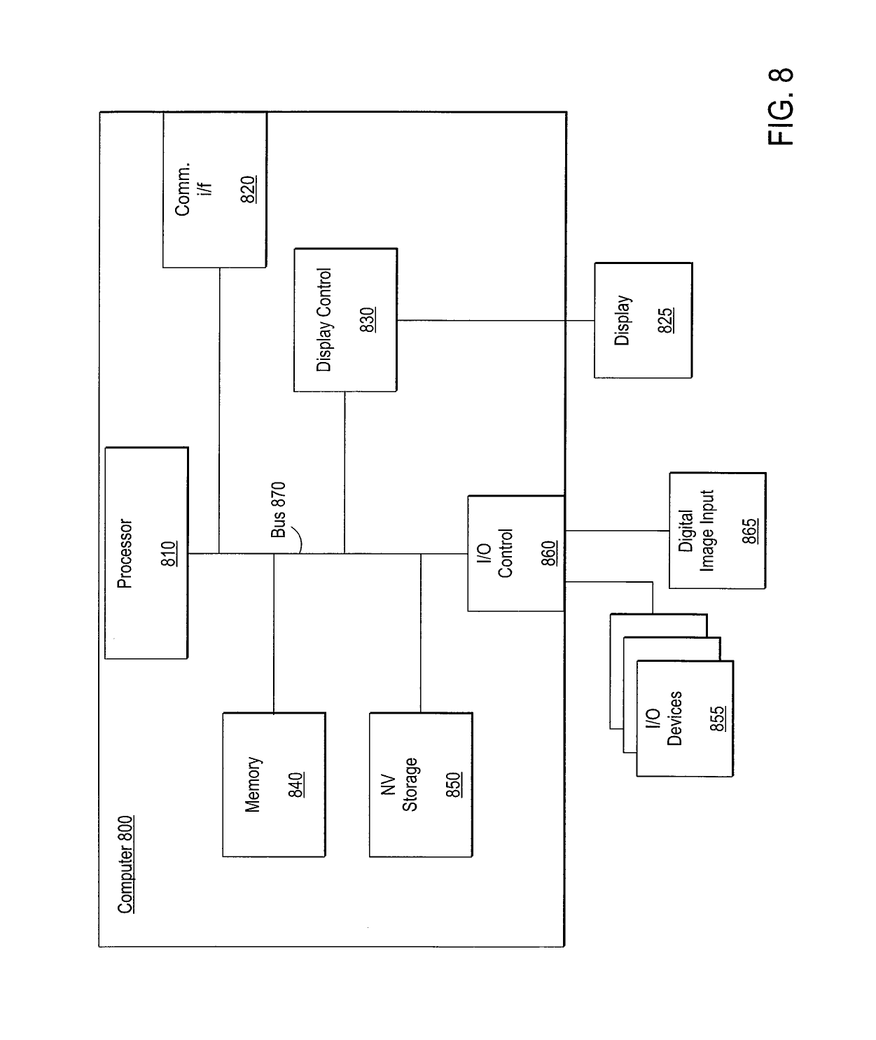

FIG. 7 illustrates an embodiment of a network which may be used with a searchroll website. FIG. 8 illustrates an embodiment of a computer which may be used with the network of FIG. 7, for example. The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

As mentioned previously, FIGS. 9-14 provide an embodiment of a user interface which may be used with searchrolls. FIG. 9 illustrates an embodiment of a user interface for creation of a searchroll. Interface 900 includes a name box, sources box, category and tags options, and cancel or submit buttons. Name box 910 allows for naming of a searchroll for future reference. Sources box 920 allows for listing of websites to be searched when the searchroll is used. The websites will be submitted along with other search parameters when a search request is presented to a search engine.

Optionally (in this embodiment), the searchroll may be categorized in dropdown menu 930. Categorization may be based on general subject matter, type of searchroll, or some other criteria. Similarly, tags or keywords may be entered in tags box 940. Such tags or keywords may be associated with the searchroll to allow a user to search a searchroll portal to identify desirable or useful searchrolls. Additionally, the searchroll may be kept private with checkbox 950, such as for searchrolls which a creator simply does not want others to use, or for searchrolls considered to be in a development stage. When the information in the previous fields has been entered, the searchroll may be created with create button 970 or canceled with cancel button 960.

With a searchroll (or searchrolls) created, the searchrolls may be displayed for use. FIG. 10 illustrates an embodiment of a user interface for interaction with searchrolls. FIG. 10 is illustrated as FIGS. 10A and 10B. FIG. 10 provides interface 1000 which includes a logo, link for creating a searchroll (which may lead to an interface such as that of FIG. 9, for example), and a series of searchrolls already available for use.

In FIG. 10A, a logo 1010 is provided as a link to a homepage. A get rolling logo 1020 is provided as a link to creation of a searchroll. High rollers 1030 are then displayed below as a set of searchrolls which may be of interest. These searchrolls may be selected randomly or rotated from among a subset of available searchrolls, for example.

Searchroll 1040 is typical in its display. An illustration (a logo, picture or other graphical representation) 1045 is provided. Similarly, Title 1050 (Near Earth Objects) and Author 1055 (Russell Schweickart) are provided. Each of objects 1045, 1050 and 1055 may be links to material. For example, illustration 1045 and author 1055 may link to a website designated by the author of the searchroll. Title 1050 may link to the searchroll in more detail. Also provided is expand button 1058, which expands into a list of websites of the searchroll 1040. Moreover, search terms box 1048 and action button 1053 are provided to allow input of search terms and activation of the searchroll using those terms, respectively.

Similarly, in FIG. 10B, searchrolls 1060 and 1080 are presented. Illustration 1065, title 1070 (Alternative Fuel Cars) and Author 1075 (Larry David) are provided, along with expand box 1078, search terms box 1068 (with terms in this instance) and action button 1073 to make up searchroll 1060. Likewise, illustration 1085, title 1090 (TPM Approved Sites) and Author 1095 (Josh Marshall) are provided, along with expand box 1098, search terms box 1088 and action button 1093 to make up searchroll 1080.

A longer listing of searchrolls may be provided. FIG. 11 illustrates an embodiment of another user interface for interaction with searchrolls. Listing 1100 is a truncated list of searchrolls for illustrative purposes. Each searchroll 1110, 1130, 1150 and 1060 includes similar elements. Thus, illustrations 1115, 1135 and 1155 along with authors 1125, 1145 and 1165 may provide links to author websites (or email links, for example). Titles 1120, 1140 and 1160 may provide links to the searchrolls respectively. Expand boxes 1128, 1148 and 1168 may provide links to expand a list of sites for each searchroll. Likewise, search boxes 1118, 1138 and 1158 along with action buttons 1123, 1143 and 1163 may allow for activation of searches.

When a searchroll is expanded to show its websites, this allows a user to inspect what is being searched, or to select a single site for searching. FIG. 12 illustrates the embodiment of FIG. 11 with an expanded searchroll. Expand button 1078 has been activated. Sources 1220 are listed as list 1225. This list of sources may be closed by either close link 1215 or collapse button 1210, for example.

Whether expanded or not, a searchroll may be used to actually search the sites of the searchroll. FIGS. 13 and 14 illustrate an embodiment of a user interface providing results of use of a searchroll. Interface 1400 presents the search results in FIGS. 13A and 13B (FIG. 13) and in FIGS. 14A and 14B (FIG. 14). Interface 1400 may be presented as one long webpage (with FIG. 14 arranged vertically beneath FIG. 13, for example).

Logo 1310 is provided as a link to a home page. Search box 1320 allows for entry of keywords, and shows keywords already searched. Links 1330 provide links to the searchroll or a general search for purposes of further searches. Similarly, drop-down menu 1340 allows for selection of other searchrolls for searching, and search button 1350 allows for activation of a search of a selected searchroll. Thus, with results of a search displayed (or a message indicating no results), a user can enter another search.

Searchroll 1060 has many of its components displayed as well, with the addition of an organization link 1360 and website list 1370 (which may be similar to list 1225 of FIG. 12). Clicking a website of list 1370 can further narrow the search to a single website in some embodiments, or point a browser to that website in other embodiments. Also provided are related searchrolls 1380 (links to other searchrolls) and tools 1390 (links to tools which may allow further use of rollyo, such as a toolbar widget for example).

Turning to the search results, FIG. 14A provides the search results. A search engine link 1410 is provided. Also, the author's name is again included to indicate who provided the searchroll. Search results 1420 are then listed. Results 1420 may be prioritized according to search engine order (without changes by the searchroll portal) or may be reordered (requiring retrieval of all results before display). As multiple pages of search results 1420 may be available, next page link 1430 is also provided, and a similar previous page link may be implemented, too.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
receiving a request to create a searchroll;
receiving a list of sites;
and
creating a searchroll to enable searching sites of the list of sites.

2. The method of claim 1, further comprising:
logging a user in.

3. The method of claim 1, wherein:
creating the searchroll includes designating the list of sites as a searchroll within a database.

4. The method of claim 1, further comprising:
presenting the searchroll to a user.

5. The method of claim 1, further comprising:
receiving a searchroll selection;
receiving a search query;
and
searching the sites of the searchroll based on the search query.

6. The method of claim 4, further comprising:
presenting search results to a user.

7. The method of claim 1, further comprising:
receiving a request to edit the searchroll;
presenting the list of sites;
receiving sites to add or delete;
and
adjusting the list of sites of the searchroll.

8. The method of claim 7, wherein:
an originator of the request to edit the searchroll is an owner of the searchroll.

9. The method of claim 7, further comprising:
checking whether a user has permission to edit a searchroll.

10. The method of claim 1, wherein:
the sites of the list of sites are of at least one of the group of: websites, FTP sites, and feeds.

11. A system, comprising:
a processor;
a memory coupled to the processor;
a user interface coupled to the processor;
a network interface coupled to the processor;
and wherein the processor is to:
receive a request to create a searchroll;
receive a list of sites;
and
create a searchroll to enable searching sites of the list of sites.

12. The system of claim 11, wherein:
the processor is further to:
present the searchroll to a user.

13. The system of claim 11, wherein:
the processor is further to:
receive a searchroll selection;
receive a search query;
and
search the sites of the searchroll based on the search query.

14. The method of claim 13, wherein:
the processor is further to:
present search results to a user.

15. The system of claim 11, wherein:
the processor is further to:
receive a request to edit the searchroll;
present the list of sites;
receive sites to add or delete;
and
adjust the list of sites of the searchroll.

16. The system of claim 11, further comprising:
means for storing searchrolls.

17. A machine-readable medium, embodying instructions, which, when executed by a processor, cause the processor to perform a method, the method comprising:
receiving a request to create a searchroll;
receiving a list of sites;
and
creating a searchroll to enable searching sites of the list of sites, including creating the searchroll in a database with the list of sites.

18. The medium of claim 17, wherein the method further comprises:
receiving advertising from a third party;
presenting advertising with presentation of a searchroll to a user.

19. The medium of claim 17, wherein the method further comprises:
receiving a searchroll selection;
receiving a search query;
and
searching the sites of the searchroll based on the search query.

20. The medium of claim 17, wherein the method further comprises:
receiving a request to edit the searchroll;
presenting the list of sites;
receiving sites to add or delete;
and
adjusting the list of sites of the searchroll.
